(19) United States
(12) Patent Application Publication
(10) Pub. No.: US 2007/0016428 A1
(43) Pub. Date: Jan. 18, 2007

(54) System and method for reducing real estate transaction fees and improving confidence in agents

(75) Inventor: Damien Gerard Loveland, Richmond (CA)

Correspondence Address: Damien Loveland, 5831 Musgrave Crescent, Richmond BC, V7C 5N6, CA

(73) Assignee: WEH-HEY! ADVERTISING INC, Richmond BC (CA)

(21) Appl. No.: 11/160,818

(22) Filed: Jul. 12, 2005

(51) Int. Cl. G06Q 99/00

(52) U.S. Cl. 705/1

(57) ABSTRACT

A low cost method for making considerable savings on real estate agents fees employing a computer system which displays, as a first feature, lists of real estate agents in a given locality who provide a transaction only service, which excludes advertising and marketing. A second feature is the display of advertisements of homes for sale which do not carry financial commitments to real estate agents, and homes wanted by people who have no agreement with an agent. A third feature is an indication of the level of ethics of the listed agents.

### BACKGROUND OF THE INVENTION

Real estate agents are well known for taking large commissions when selling a home, especially in North America, where commissions are typically in the range of 3-7% of the value of the home. The commission is pegged to the value of the home, rather than the value of the service. If an owner has only a low equity in the home, then the commission relative to the owner's equity can be very large.

The public do not have a good perception of the real estate agent profession according to the results of Gallup's annual Honesty and Ethics survey. Since entering the poll in the late 1970's, real estate agents have not attained greater than a 17% public confidence rating for possessing high or very high ethics.

A member of the public is at a great disadvantage when doing business with a real estate agent. Real estate agents market themselves and negotiate deals on a daily basis, whereas a member of the public may only buy and sell a home perhaps every six or ten years. A real estate agent's aim is to make himself a living, which in crude financial terms translates into making the most commission with the least possible effort. Quality of service does vary between real estate agents, according to their ethics and their desire to get repeat business or recommendations from past clients, but some estate agents consider their trade to be passing trade. The reality is that a significant number of people will never use the same real estate agent a second time and it remains a problem to find a good real estate agent.

In a North American region of say about 1.5 million inhabitants, there could be approximately 8,000 real estate agents and about 36,000 home sales per year. In this case, the average real estate agent will on average sell 4.5 houses and buy 4.5 houses annually. In order that such a real estate agent can make a living, the average commission received per transaction needs to be very high, say several thousand dollars. This amount could be equivalent to several months of a home buyer or seller's wage, or even several years of savings, and it could all be spent on just a few hours or a couple of day's work of a real estate agent. The fact that an average real estate agent only manages to do nine transactions per year also indicates the inefficiency in the profession as a whole.

One particular problem when selling a home is that the seller is not just competing against other houses for sale, he is competing to attract buyers' real estate agents. This is why a seller must allocate a large sum of money from the sale price in order to get attention from the buyer's agents. Once allocated, this amount cannot usually be reduced. Making this predetermined amount a condition of being able to list a home for sale with an agent is a way for the real estate industry as a whole to take advantage of the individual home seller directly and buyer indirectly. If the principle of a free market applied, buyer's agents would be paid according to the value of their services, and should really be paid by the home buyer rather than the home seller.

When buying, in the traditional mode of business, a real estate agent acting as a buying agent will say that he is working for the buyer for absolutely no cost. However, it is in the buying agent's best immediate financial interest to steer the buyer towards the homes for which he receives the most commission. The real cost, at a minimum, is what the buying agent receives and could conceivably be that the buyer does not get the home he really wanted. The buyer usually has absolutely no control over the cost of the service he gets.

Many real estate agents have an online presence, using web sites and databases for providing information to prospective buyers and sellers. In many cases this is simply an online presence and not a means for reducing cost to the consumer, improving the public perception of real estate agents or opening up the market.

There are several patents describing real estate databases, such as U.S. Pat. No. 6,883,002, U.S. Pat. No. 5,794,216, U.S. Pat. No. 5,235,680, U.S. Pat. No. 5,146,548, U.S. Pat. No. 5,032,989, U.S. Pat. No. 4,870,576, and U.S. Pat. No. 5,754,850, which in general describe some feature claiming to improve the operation or ease of use of such databases, or adding to their functionality. None of these are a means for significantly reducing cost to the consumer, improving the public perception of real estate agents or opening up the market.

A few sites allow buyers to submit initial bids online. U.S. Patent Application Publication No. 2002/0123959 describes a system and method for providing a real estate auction system. U.S. Pat. No. 5,664,115 describes a method and apparatus for matching sellers of property with potential buyers who have been pre-screened. None of these are a means for significantly reducing cost to the consumer, improving the public perception of real estate agents or opening up the market.

U.S. Pat. No. 6,751,596 goes some way towards recognizing that real estate agent fees are too high by providing a system in which a purchaser can act without an agent and recover the commission allocated by the seller to a buyer's agent. However, this method still requires paying the listing agent a large commission.

There are some attempts to tackle the problem of finding an ethical real estate agent. U.S. Patent Application Publication No. 2004/0088172 describes a system whereby one can choose a so-called good real estate agent, but this method assumes that the quality of real state agents is directly proportional to his earnings, rather than his ethical standards. U.S. Patent Application Publication No. 2002/0099592 describes the sale of reports relating to negotiation, execution and evaluation of prior leases, which will help others decide whether to use the same professionals referred to in the reports.

In some cases, people sell their homes by owner in order to completely avoid dealing with a real estate agent. There are several FSBO (For Sale By Owner) internet companies which facilitate this process. Generally speaking, sales by this method form a much lower share of the market than traditional agent assisted sales. The FSBO method is not so popular because many potential sellers would not have the confidence to manage their own sale in its entirety, and many potential buyers would not be exposed to such homes for sale if they have an agent of less than perfect ethics. FSBO Advertising Service Inc, for example, are now offering traditional agents' advertising services, on the MLS® system, but this still requires conditionally committing a large amount of money to a buyer's agent in advance. Some online companies such as hwy16.ca will advertise both FSBO homes as well as those sold by agents. Many people will not be happy with these two options. The FSBO route will be too difficult and the traditional agent route will be too expensive.

A small number of real estate agents provide professional representation to those people selling or buying homes on their own, but there is no systematic way for this type of service to be provided on a large scale to a large number of people.

There can be found on the internet several lists of real estate agents, and some of the lists can be searched according to the speciality of the agent, such as whether the agent deals with residential real estate, commercial real estate, acreage, lots, farms, and languages spoken. None of these lists specifiy whether or not the agent will offer transaction only services or provide an indication of what past clients think of the quality of service of such agents.

Some online companies will sometimes charge low commission on the selling side of the transaction. There is no provision to represent the buyer unless the seller again commits a large amount of money to a buyer's agent in advance. Like with traditional agent services, if a buyer's agent commission is offered, the seller does not have the option to reduce the commission if such an agent only brings a low quality offer to the table.

None of the prior art disclosures provide a system or method that enables savings on usual real estate agent commissions in the region of 90% or more, while still allowing both buyers and sellers to retain at the closing stage of a transaction the services of a real estate agent to help with the tasks which are most difficult for the average member of the public to accomplish unaided.

What is needed is a low cost system which obviates the need for home sellers to commit up front to a predetermined buyer's agent commission. It needs to enable low cost real estate agent fees while at the same time being comfortable for the average home buyer and seller, which means it will allow the users to select the most ethical real estate agents for the critical part of the transaction, and it will be convenient to use. Furthermore, the system should allow sellers and buyers to freely access the market for buyer's agent commissions.

### SUMMARY OF THE INVENTION

The invention is a system to provide online lists of contact details for real estate agents who provide transaction only services. Individuals accessing the lists will be able to inexpensively market or search for their own home on the website by their own efforts, and pay the real estate agent a much reduced fee for services to complete the real estate transaction, whether for the buying side, the selling side or both. Lists of such agents will be readily or freely available to the public, and will be compiled from a database according to the locality the individual is interested in. The lists will help the individual users to discern which real estate agents are the most ethical by the possibility of including client feedback ratings. The invention may be combined in a website with other features related to real estate. In the spirit of the internet, it is cheap to use and it allows users to save considerable amounts of money. It also retains for the individual the user comfort of working with a real estate agent and it improves the confidence of the individual in the ethics of the real estate agent.

### BRIEF DESCRIPTION OF THE DRAWINGS

FIG. 1 shows a simplified view of the system

FIG. 2 shows a flowchart of the software

### DETAILED DESCRIPTION OF THE INVENTION

The core of the new software and computer based process described herein is the provision, conveniently and at little or no expense to the home buyer or seller, a searchable list of real estate agents who provide transaction only services. This does not preclude the agents from offering full services too, or any other type of service. Transaction only services include one or more of the provision of a contract to buy and sell real estate, advice on how to complete a contract to buy and sell real estate, writing an offer or counter offer to buy real estate, writing an offer or counter offer to sell real estate, negotiation on behalf of the vendor or purchaser, representation of the vendor or purchaser, management of a real estate transaction, coordination with third parties to the transaction; but excludes advertising, marketing and chaperoning clients who are viewing homes. While some agents are already willing to provide this kind of service, it is not generally in their best financial interest to advertise it widely because they would rather convince prospects into purchasing full services or simply have clients who are already prepared to pay for full service. What is needed is a list of such agents which is readily available to the public, in order to to facilitate large numbers of individuals to choose transaction only services.

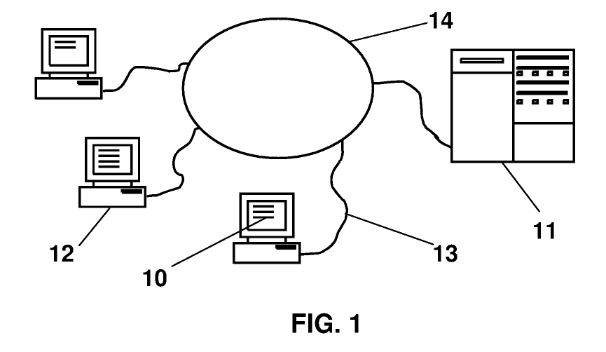

In carrying out the above objects and referring to FIG. 1, the present invention provides a device, such as a server 11, for storing information about a plurality of real estate agents and related information for access by an application program executed on the same or different server, a computer or other like programmable apparatus. Included is a computer-readable storage medium carrying computer-readable data. The computer-readable data is representative of a database comprising information for each real estate agent. Also included is a data transmission means, such as the internet 14, providing a signal path 13 for data exchange between said server and one or more remote data terminals such as a personal computer 12 or wireless laptop. Software driven processing of data occurs on a processor, which may be in a server, resulting in the information 10 being displayed by browser software on the remote data terminals.

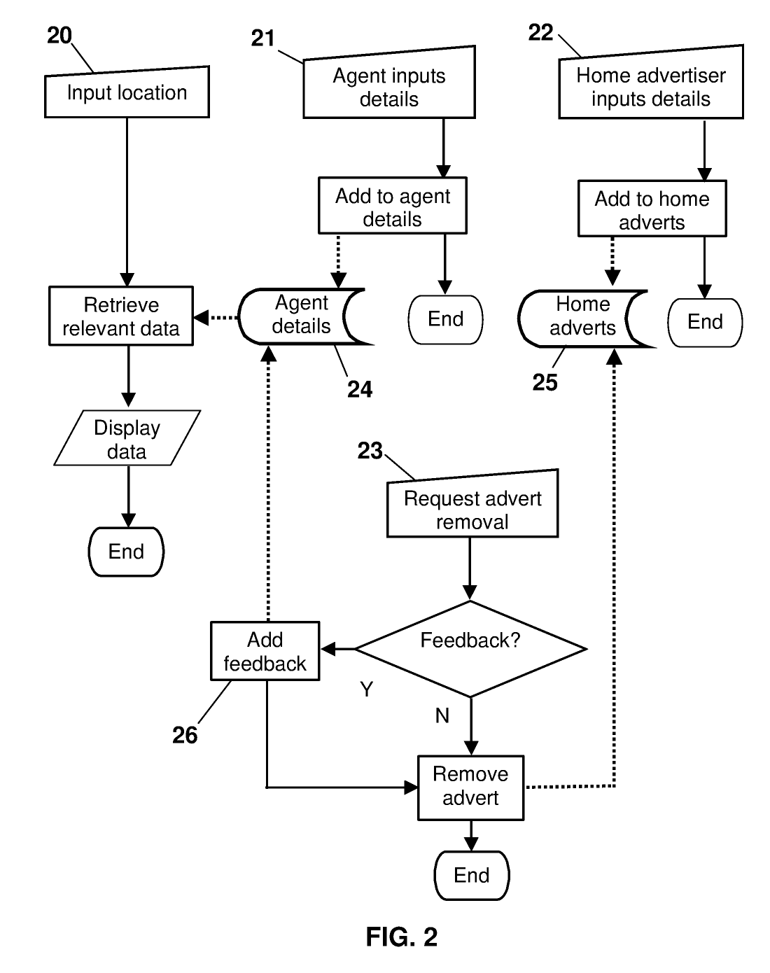

The invention is most convenienly provided on a website which is preferably free for the public to browse. Referring to FIG. 2, the list of transaction only real estate agents is, ideally, searchable, so that when an individual inputs a location 20 via a browser on a remote terminal, the software will retrieve the relevant data from the agent details database 24 and only the agents working in the locality of the individual's interest will be displayed. Home buyers and sellers looking to save on agents' fees will visit the site and know that each agent listed will offer transaction only services, without having to go to the effort of reading the print of numerous newspaper advertisements, visiting several different websites or partaking in numerous rounds of emails and phone calls. Agents wishing to subscibe to the list may input their contact details 21 which will be added by the software to the database of agent details 24. Once this list is in existence and independently controlled, agents willing to provide transaction only services should find they are better off compared to other agents by being on the list than off it. Given that full service clients will probably sign up with agents directly, and that clients looking for savings are more likely to search the internet first, the included agents should gain extra business. The extra business created will allow them to more rapidly increase their client base, because fewer hours would need to be spent on each client. Gradually, as the public become more aware of the transaction only option and make more use of it, the market will gradually become more competitive, to the benefit of the general public. Along with this, the most competitive and ethical members of the real estate industry will also benefit.

This creation of this type of list would not be obvious for an individual real estate agent, because it would be against his financial interests. It would involve advertising other agents in an already overcrowded market, and would educate potential full fee clients as to the low cost option of transaction only services. It would not be obvious to real estate franchising companies, because it is a method of reducing their overall income. It is not obvious to real estate boards as their interests would be to have as many subscribing members as possible, and to have as much power over the industry as possible, whereas this method provides more control to the public by providing choice and opening up the market. It is not obvious for those FSBO companies whose fundamental principle is to avoid any use of a real estate agent. Some individuals, who are not experts in the field of real estate, may have already entered into the type of real estate transaction proposed here by chance, but it is not obvious how to make something that happens by chance into something that happens regularly and on a large scale.

A supporting feature of the invention is the ability to provide searchable advertisements of homes for sale and homes wanted. Inclusion in the advertisements will cost the advertiser a small fee appropriate for the internet, comparable to the cost of a newspaper classified, but for a significantly longer insertion time. A home advertiser, whether advertising a home wanted or home for sale, inputs the details 22 which are then added by the software to the searchable database of home advertisements 25. What is novel about these advertisements is that the homes are neither defined as FSBO, nor do they carry a fixed commission. At any one time, there is an existing pool of buyers actively looking for homes, and this website will provide a seller inexpensive access to such buyers. It is a convenient and inexpensive opportunity for a buyer and seller to meet and decide that they want to enter into a contract for purchase and for sale, before they commit to a real estate agent to help them with the formal transaction. This way, a buyer's agent does not spend inordinate amounts of time searching for a home and a seller's agent does not incur large advertising costs. Since about ¾ of home buyers now use the internet to search for a home, and they are able to do this without the help of a real estate agent, many of them will find the website and search the home advertisements, and while on the website discover that it is easy to select an agent who will charge just a transaction only fee for finalizing the real estate transaction. The amount payable for such a transaction will be typically a tenth or less of the fee for an agent's full service. It is conceivable that either one agent will help both parties to the transaction, or each party will have his own agent. In contrast with FSBO type sales, the individual home buyer or seller retains the comfort of working with a professional real estate agent during the most critical part of the real estate transaction process. Nevertheless, the possibility still remains that one or more lawyers will be used for the completion of the contract instead of real estate agents, which some people may prefer.

A further beneficial feature of the invention is the inclusion, in the website containing the list of transaction only real estate agents, the ability of clients of these agents to provide to the website feedback 26 about the quality of service they have received from the real estate agents. The feedback may be displayed alongside the contact information for each real estate agent, or it may be provided on another, hyperlinked web page. The mere possibility of this happening will discourage the less ethical agents from joining the list, and be a continual inducement for all agents on the list to maintain a high standard of ethics. While the notion of past clients recommending or not recommending service providers is not new, and the online provision of feedback is not new, there is no existing solution to easily capture feedback from clients of real estate agents. The function of the software operating on the website is such that the home advertiser must request that the advertisement be removed 23 if completion of a transaction occurs before a set time period, and the software at the time of the request will prompt the advertiser to provide feedback to the site, which will involve minimal effort.

An alternate embodiment of the current invention is a website of searchable advertisements of homes for sale and/or homes wanted, which also comprises a locality searchable list of real estate agents to which clients of those agents on the list can independently publish feedback. In this case, the advertisements may be placed by real estate agents or other individuals, and commission may or may not be allocated in advance of the sale. The reason that people will take the trouble to browse to the list is that it will be obtainable via a website containing information on houses for sale or wanted. The feedback will not be edited by the real estate agents, nor will the real estate agents have any control over which feedback is published and which is not. This will certainly improve the confidence subsequent clients will have in choosing a suitable real estate agent, and where the feedback contains information about fees charged it will tend to open up competition and generally reduce the fees charged.

Additionally, the system may display contact information for a locality dependent selection of real estate lawyers, lenders, mortgage brokers, home inspectors, painters, builders, remodellers or other professionals providing services to the real estate industry. The system can be related to commercial real estate, residential real estate or both. It could also be applied to real estate rentals and leases.

What is claimed is:

1. A system for displaying contact information for a locality dependent selection of real estate agents whose services include, but are not limited to, a transaction only service, comprising:
a server, one or more remote data terminals each with a display device, data transmission means providing a signal path for data exchange between said server and said one or more data terminals, data storage means within a server, and processing means within a server;
wherein said transaction only service comprises one or more of:
provision of a contract for the purchaser to buy and the vendor to sell real estate, advice on how to complete said contract, writing an offer or counter offer to buy real estate, writing an offer or counter offer to sell real estate, negotiation on behalf of a real estate vendor or purchaser, representation of the real estate vendor or purchaser, management of a real estate transaction, and coordination with third parties to the transaction;
wherein said transaction only service excludes advertising and marketing;
wherein said contact information comprises one or more of:
a telephone number, an address, an email address, a website address and a hyperlink;
and wherein the term real estate agent includes real estate brokers, realtors and all people performing similar functions to real estate agents.

2. The system according to claim 1 wherein one or more said servers and said one or more remote data terminals exchange data through the internet.

3. The system according to claim 2 operative via a website comprising searchable access to advertisements of homes for sale, homes wanted or both homes for sale and homes wanted.

4. The system according to claim 3 wherein an individual requesting the removal from the website of an advertisement is prompted to provide feedback about one or more of the real estate agent and service providers used by said individual in a real estate transaction.

5. The system according to claim 1 wherein said information additionally comprises contact information for a locality dependent selection of real estate agents who do not provide a transaction only service, and further comprises informative means for distinguishing between the real estate agents who provide a transaction only service and the real estate agents who do not provide a transaction only service.

6. The system according to claim 1 wherein said information additionally comprises for each real estate agent an indication of the satisfaction of said real estate agent's clients with said real estate agent's service.

7. The system according to claim 1 wherein said information additionally comprises contact information for a locality dependent selection of service providers from one or more of the following groups: real estate lawyers, lenders, mortgage brokers, home inspectors, painters, builders, remodellers and other professionals providing services to the real estate industry.

8. The system according to claim 7 wherein said information additionally comprises for each service provider an indication of the satisfaction of said service provider's clients with said service provider's service.

9. A system for displaying contact information for a locality dependent selection of real estate agents and feedback about one or more of said real estate agents independently provided to said system by clients of said real estate agents, comprising:
a server, one or more remote data terminals each with a display device, data transmission means providing a signal path for data exchange between said server and said one or more data terminals, data storage means within a server, and processing means within a server;
wherein the system is operative via a website comprising searchable access to advertisements of homes for sale, homes wanted or both homes for sale and homes wanted;
wherein said contact information and said feedback are displayed on the same or different display pages;
wherein said contact information comprises one or more of:
a telephone number, an address, an email address, a website address, and a hyperlink;
wherein said feedback comprises one or more of:
individual comments provided independently by clients, details of commission charged, the number of clients who have left feedback, a compiled rating, and details of how the rating has changed over time;
and wherein the term real estate agent includes real estate brokers, realtors and all people performing similar functions to real estate agents.

10. The system according to claim 9 wherein a feedback rating for a real estate agent, contact details for said agent and a home advertisement listed for sale by said agent are displayed on the same page, wherein said contact details comprise one or more of: a telephone number, an address, an email address, a website address, and a hyperlink.

11. A method for reducing the cost of real estate transactions comprising:
storing, within a data storage means in a server, contact details for real estate agents whose services include, but are not limited to, a transaction only service;
accepting from a user, via a remote data terminal or other input device, an input indicative of a locality in which the user may want to buy or sell a home;
processing said input, on a processing means within a server, in order to select from said contact details, information relating to real estate agents operating in the locality indicated by the input of the user;
transmitting the selected information, via data transmission means, to the user's remote data terminal;
displaying, on the user's remote data terminal or other display device, contact information for a locality dependent selection of real estate agents who provide at least a transaction only service;
wherein said transaction only service comprises one or more of:
provision of a contract to buy and sell real estate, advice on how to complete a contract to buy and sell real estate, writing an offer or counter offer to buy real estate, writing an offer or counter offer to sell real estate, negotiation on behalf of the vendor or purchaser, representation of the vendor or purchaser, management of a real estate transaction, and coordination with third parties to the transaction;
wherein said transaction only service excludes advertising and marketing;
wherein said information comprises one or more of:
a telephone number, an address, an email address, a website address and a hyperlink;
and wherein the term real estate agent includes real estate brokers, realtors and all people performing similar functions to real estate agents.

12. The method according to claim 11 wherein said server and said one or more remote data terminals exchange data through the internet.

13. The method according to claim 12 operative via a website comprising searchable access to advertisements of homes for sale, homes wanted, or both homes for sale and homes wanted.

14. The system according to claim 13 wherein an individual requesting the removal from the website of an advertisement is prompted to provide feedback about one or more of the real estate agent and service providers used by said individual in a real estate transaction.

15. The method according to claim 11 wherein information displayed on the user's display additionally comprises contact information for a locality dependent selection of real estate agents who do not provide a transaction only service, and further comprises informative means for distinguishing between the real estate agents who provide a transaction only service and the real estate agents who do not provide a transaction only service.

16. The method according to claim 11 wherein said information additionally comprises for each real estate agent an indication of the satisfaction of said real estate agent's clients with said real estate agent's service.

17. The method according to claim 11 wherein said information additionally comprises contact information for a locality dependent selection of one or more of the following groups: real estate lawyers, lenders, mortgage brokers, home inspectors, painters, builders, remodellers and other professionals providing services to the real estate industry.

18. The method according to claim 17 wherein said information additionally comprises for each service provider an indication of the satisfaction of said service provider's clients with said service provider's service.
